(19) United States
(12) Patent Application Publication
(10) Pub. No.: US 2015/0087381 A1
(43) Pub. Date: Mar. 26, 2015

(54) MULTIPLE DRAW SETS KENO

(71) Applicant: IGT, Las Vegas, NV (US)

(72) Inventor: Kyle A. Larson, Belgrade, MT (US)

(21) Appl. No.: 14/033,297

(22) Filed: Sep. 20, 2013

(51) Int. Cl. G07F 17/32

(52) U.S. Cl. CPC G07F 17/3288
USPC 463/18

(57) ABSTRACT

An exemplary embodiment relates to a method of providing a game that includes displaying a board showing a plurality of spots. Draws for a plurality of draw sets are selected. A number of draws hitting each spot on the board are determined. The display of the board is updated to indicate the selected draws. Payout to the player is calculated based on the determined number of draws hitting each spot on the board.

### BACKGROUND

The present disclosure relates generally to wager-based games and more particularly to keno games and slot games. During a keno game, a player wagers by selecting numbers on a keno board. A predetermined number of draws are generated by the keno game and indicated on the keno board. A payout to the player is based on matches found between the draws and the player-selected numbers. A paytable may dictate the payout amount that is due to the player depending on the number of matches detected.

During play of a slot game, a player chooses to wager on a number of paylines. The slot game generates an outcome based on a random determination.

### SUMMARY

An exemplary embodiment relates to a method of providing a keno game to a player. The method includes displaying a board showing a plurality of spots. The method further includes selecting, using one or more processors, draws for a plurality of draw sets. The method further includes determining, using the one or more processors, a number of draws hitting each spot on the board. The method further includes updating the display of the board to indicate the spots on the board that are hit. The method further includes calculating, using the one or more processors, payout based on the determined number of draws hitting each spot on the board.

Another exemplary embodiment relates to an electronic device for playing a keno game. The electronic device includes a display configured to display the keno game to a player having a keno board with a first predetermined number of keno board spots. The electronic device further includes a user-input panel. The electronic device further includes a game controller having one or more data processors and one or more storage devices storing instructions that when executed by the one or more data processors, cause the one or more data processors to perform operations comprising: displaying a board showing a plurality of spots; selecting draws for a plurality of draw sets; determining a number of draws hitting each spot on the board; updating the display of the board to indicate the selected draws; and calculating payout based on the determined number of draws hitting each spot on the board.

Yet another exemplary embodiment relates to a method of providing game play of a wager-based game through a gaming machine having a controller. The method includes displaying a grid comprising a plurality of grid spots. The method further includes receiving a player selection of a plurality of grid spots. The method further includes determining, by the controller, a symbol for each grid spot in the grid. The method further includes determining, by the controller, that symbols shown in each player selected spot match. The method further includes calculating payout to the player based on the determined match.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIGS. 1A-D are illustrations of a game allowing for multiple sets of draws, in an accordance with an example implementation;

FIGS. 2A-D are illustrations of a game allowing for multiple sets of draws and player selections, in an accordance with an example implementation;

FIGS. 3A-B are illustrations of a slot game allowing the player select segment locations on reels, in an accordance with an example implementation;

FIG. 4 is a flow diagram of a process for providing a game that allows for drawing of multiple sets of draws, in an accordance with an example implementation; and

FIG. 5 is a diagram of an electronic gaming machine that can be used to play the games shown in FIGS. 1A-D, FIGS. 2A-D, and FIGS. 3A-B, in an accordance with an example implementation.

### DETAILED DESCRIPTION

Numerous specific details may be set forth below to provide a thorough understanding of concepts underlying the described embodiments. It may be apparent, however, to one skilled in the art that the described embodiments may be practiced without some or all of these specific details. In other instances, some process steps have not been described in detail in order to avoid unnecessarily obscuring the underlying concept.

According to various embodiments disclosed herein, a new type of keno gaming machine is provided. The gaming machine provides a board similar to a regular keno game. The board may consist of any number of spots (e.g., 80 spots, 100 spots, etc.). During game play, multiple sets of random spots are drawn and marked on the board. The game may pay out for each spot with multiple hits exceeding a threshold value (e.g., for each spot having three hits or more). When the same spot is hit with all the sets of drawn spots, additional awards and/or draws may be awarded. The concept of drawing multiple sets of spots may be used to build objects during a game, to break down objects, or break apart an object to win.

At the start of the game, a board with a predetermined number of spots may be shown. The board may be cleared of any previous wins. If extra draws were awarded in a previous game, they may remain on the board. For example, a board with eighty spots may be shown. Next, multiple sets of spots are randomly drawn and indicated on the board. For example, four sets of twenty random spots may be drawn. In some embodiments, each set of draws is drawn without replacement from the eighty available spots. In other words, twenty of the eighty spots are drawn randomly each time, without consideration of any previous drawn set of spots.

In some implementations, the total number of hits detected for each spot on the board (if any) may be indicated with color on each board spot. For example, the background color of spots that each match one draw from the drawn sets is updated to red color (or any other color), while the background color of spots that each match two draws from the drawn sets are updated to yellow color (or any other color). In this example, the background color of spots that each match three draws from the drawn sets is updated to green color (or any other color), while the background color of spots that each match four draws from the drawn sets are updated to gold color (or any other color). Any other types of visual indicators may be used to indicate to the user the number of hits on each board spot. For example, a 3-D visualization may be used to depict the number of matching draws for each spot.

For example, after the board is cleared of any marks except for any draws carried over from previous games, four sets of draws may be drawn. First, the first set of twenty spots are randomly drawn and indicated on the board. At this point, the board spots that have one draw may be updated to be the same color (e.g., red color). Next a second set of twenty spots are randomly drawn from the eighty available spots and indicated on the board. If any of the draws from the second set land on the same board spot as the draws from the first set, those spots may be emphasized to the user. For example, those spots may be shown in yellow color. Next, the third set of twenty spots is randomly drawn and indicated on the board. Any spots that have draws from each of the three sets may be shown in a different color such as green. Finally, the fourth and last set of twenty numbers is randomly drawn and indicated on the board. At this point, the spots that have draws from each of the four sets may be shown in gold color. Thus, a spot that was green before the fourth set of spots was drawn may change to gold if a draw from the fourth set of spots hits this spot. Thus, at the end of the game, the board spots may include red, yellow, green, and gold spots. In some implementations, the green and gold spots may be the winning spots.

For each green and gold spot, the player may receive a monetary award that may be multiplied by a bet multiplier. If the number of the winning spots (i.e., green and gold spots) is high enough, the player may also be awarded an additional multiplier based upon the total number of winning spots. In some implementations, the extra draws awarded may be accumulated and preserved for the next game or for a predetermined number of subsequent games (e.g., three games). In these implementations, the extra draws that have been used (e.g., for three games) may be discarded.

In one implementation, the player does not select any marks on the board, and the payout is based on the number of winnings spots as discussed above. In another implementation, the player can select a predetermined number of spots. For example, the player may select three spots. The player may have the option to keep the current marks or to erase them and choose new marks. When the player is allowed to select spots on the board, another objective of the game is for the draws to hit the player marked spots at least threshold number of times (e.g., at least three times).

After the player selects spots on the board, and the multiple sets of draws are drawn, the payout is calculated in part based on whether any draws hit the player's marked spots. Different awards may be awarded to the player when the draws hit one or more of the player's marks at least a threshold number of times. For example, if one of the player marked spots is hit at least a threshold number of times by the draws (e.g., at least three times), then a bonus may be triggered or a scatter award given to the player. The bonus game that is triggered includes: a slot game, a card game such as a video poker game, a keno game, a bingo game, a selection game, a skill-based or pseudo-skill based game. If two of the player marked spots are hit at least the threshold number of times, then a predetermined number of free games may be awarded. If all three marked spots have been hit at least three times, then a predetermined number of free games are awarded and a play with ten extra draws on the last set. In another implementation, a multiplier can be applied.

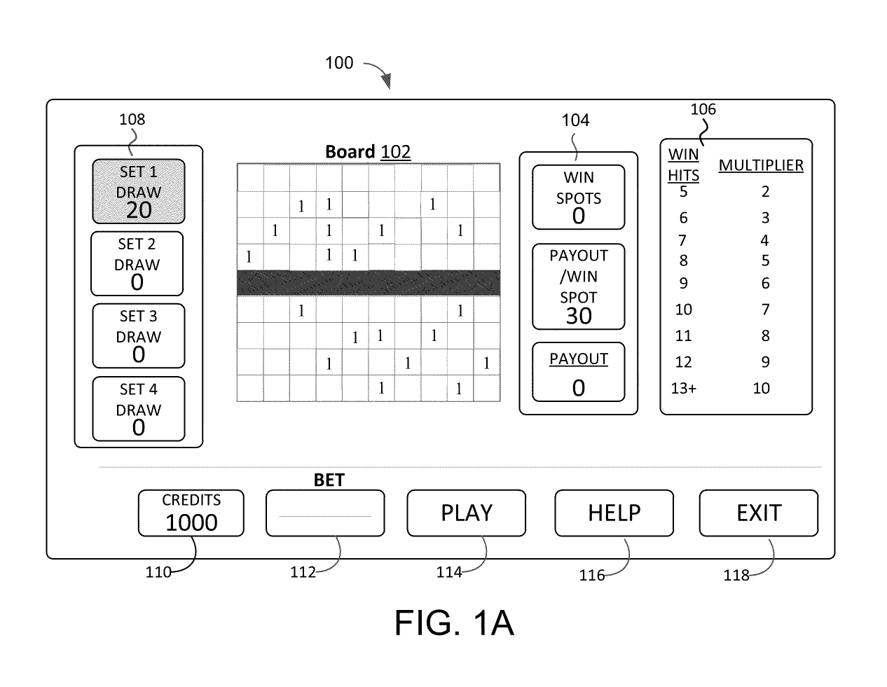

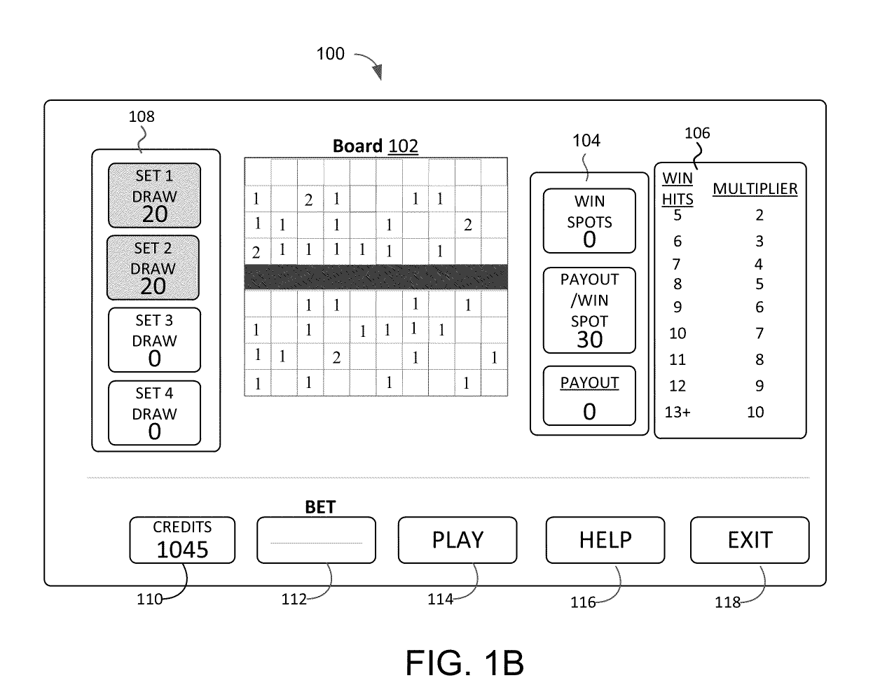

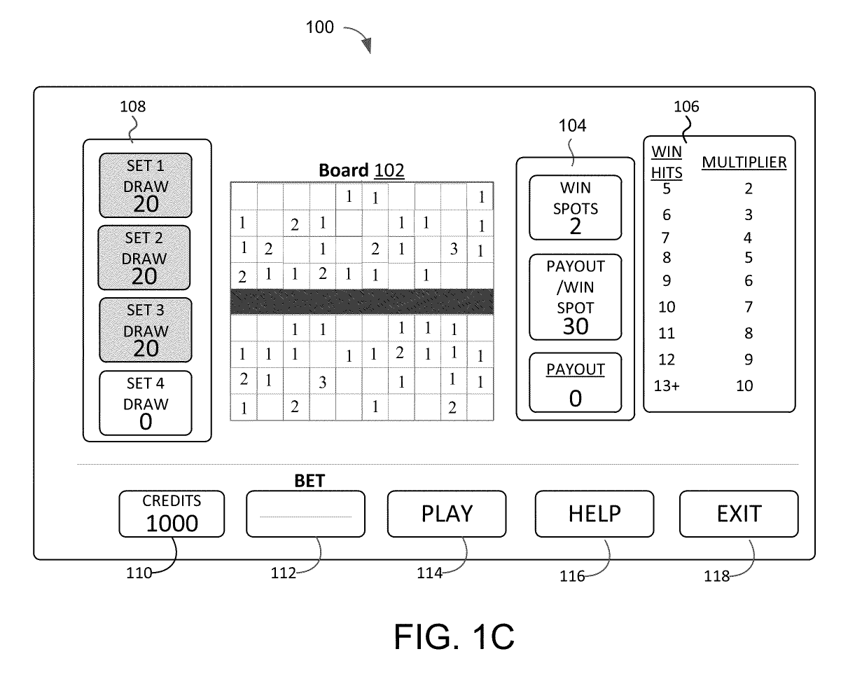

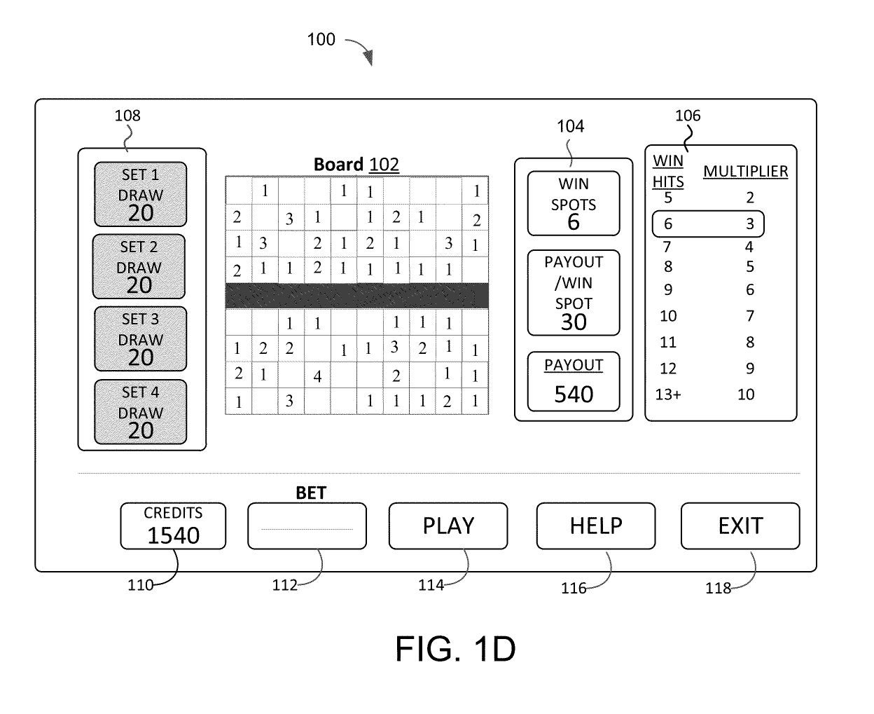

FIG. 1A illustrates a game 100, during which a player does not select any spots and multiple sets of draws are drawn without replacement. A board 102 is displayed with eighty board spots. Although each spot on the board 102 is shown as a separate square, the board spots may be shown on the board 102 as numbered balls, numbered squares, or another visual representation. As shown, the player has not selected any spots on the board.

As shown in a section 108, a first set of spots are drawn out of four sets that are to be drawn during the game 100. Twenty numbers are randomly drawn by the game out of the eighty available numbers. The board is updated with the first set of drawn numbers by marking each corresponding board spot with “1” to indicate that those spots were hit once by draws. Although the board is updated with “1”s to display the draws, any other visual indicators other than the “1”s may be used to signify the drawn spots. For example, the spots that correspond to the drawn numbers may be updated to the color red or any other color to signify that those spots were hit by draws once thus far.

Section 104 displays the total number of win spots, payout per win spot, and the total payout earned by the player during the game 100. Although the section 104 displays that the number of credits per winning spot is thirty, any number of credits or other types of awards may be assigned for each winning spot. A paytable may be provided to calculate the payout for different numbers of winning spots (e.g., 100 credits for 4 winning spots, 300 credits for 5 winning spots, etc.).

In one implementation, to qualify as a win spot, a spot on the board 102 needs to be hit by three or more draws (or any other number). In other words, draws from three or more sets of drawn numbers need to hit the spot. As shown, because only one set of numbers was drawn, there are no winning spots detected yet. As each set of drawn numbers is shown on the board, the number of winning spots may increase.

If the number of winning spots is 5 or more, the player will receive an award multiplied by a bet multiplier. A paytable 106 illustrates multipliers associated with various total levels of winning spots. For example, as shown, if a total number of five winning spots are detected, then a multiplier of 2 is applied to the number of credits earned by the player.

Controls for the game 100 may be provided to the player. As shown, buttons 114, 116, and 118 are provided to enable the player to play, get help, or exit the game 100 respectively. The total number of credits earned by the player is shown in a field 110. The player can also enter a bet into a field 112.

FIG. 1B illustrates results of a second set of spots being drawn during the game 100. As summarized in the section 108, a second set of twenty numbers was drawn. In particular, twenty numbers are randomly (or pseudo-randomly) drawn from the available eighty numbers without consideration of the first set of drawn numbers. In other words, both sets of numbers (i.e., first set of numbers and second set of numbers) are drawn from the same set of eighty numbers. Accordingly, duplicate numbers may be drawn between the two sets of numbers.

The board is updated with the second set of twenty drawn numbers. Four of the drawn numbers in the second set match the drawn numbers in the first set and are marked as “2”s on the board. The drawn numbers in the second set that do not match the numbers from the first set of drawn numbers are marked on the board as “1”s to indicate that the corresponding marked spots have only been hit once so far.

As shown, although four of the draws from the second set of drawn numbers match the draws from the first set of numbers, none of the draws count as winning spots because only two sets have been drawn and three or more hits are required for a spot to qualify as a winning spot. Thus, the payout to the player is still zero.

Now referring to FIG. 1C, results of a third set of spots being drawn during the game 100 are illustrated. As shown in the section 108, three out of the four sets were drawn. The third set of twenty numbers is randomly (or pseudo-randomly) drawn from the available eighty numbers without consideration of the first two sets of drawn numbers. Thus, the three sets of numbers, twenty numbers each, are drawn from the same set of eighty numbers.

The board is updated to display the third set of twenty drawn numbers. Two of the drawn numbers in the third set match the drawn numbers in the two drawn sets and are marked as “3”s on the board 102. Some of the drawn numbers in the third set match the numbers drawn in the first set of drawn numbers, while some drawn numbers in the third set match the numbers drawn in the second set of drawn numbers. Thus, some of the spots were updated to show “2” instead of “1”. As a result, a total of nine spots labeled as “2” are shown on the board 102. Spots that were not hit by draws in the first two sets of drawn numbers but which are hit by the spots in the third set of numbers are labeled as “1”.

The two spots on the board that were hit by the draws from all three sets are considered winning spots because they were hit three or more times (in this case three times). As shown in the section 104, there are two winning spots, and the payout is 30 credits per wining spots. Thus, the payout amount is 60 credits (i.e., 30 credits multiplier by 2 for the 2 winning spots). No multiplier is awarded because none of the spots on the board 102 had draws from all four sets since the last set of numbers has not been selected yet.

FIG. 1D illustrates the fourth and last set of spots being drawn during the game 100. For the fourth set, twenty numbers are randomly (or pseudo-randomly) drawn from the available eighty numbers without consideration of the first three sets of drawn numbers. Thus, as result of these numbers being drawn, some of the spots on the board may have no hits between the four sets of drawn numbers, while other spots on the board may each have one hit from one of the four sets of drawn numbers. Other spots on the board may each have two hits from any of the four sets of drawn numbers. For example, one spot on the board may have a hit from the first set and a hit from the third set, while another spot on the board may have a hit from the second set and a hit from the fourth set. Other spots on the board may each have three hits from any of the three sets of drawn numbers (e.g., a hit from the first, second and fourth sets).

Although not shown during the game 100, one or more spots on the board 102 may have hits from each set of draws. For example, a spot may have hits from a first set of draws, a second set of draws, a third set of draws, and a fourth set of draws. When the total number of winning spots is five or more, a multiplier may be assigned in accordance with the paytable 106. The multiplier may be applied to the total number of credits earned by the player after the current set of draws was selected. In another implementation, the multiplier is applied to the cumulative payout earned by during all the draws of the current game.

A total of six spots are detected that have three or more hits. In particular, one spot (labeled as “4”) on the board 102 has hits from all four drawn sets, while five spots (labeled as “3”) each have three hits. These spots qualify as winning spots, which is indicated in the section 104. Payout for these six winning spots is one hundred eighty credits (i.e., 30 times 6). In addition, the player is awarded a multiplier in accordance with the paytable 124 because a total of six winning spots was detected. Thus, the total payout is one hundred eighty multiplied by the multiplier three, which results in five hundred and forty credits. The total credits field 110 is updated with the earned 540 credits for a total of 1,540 credits.

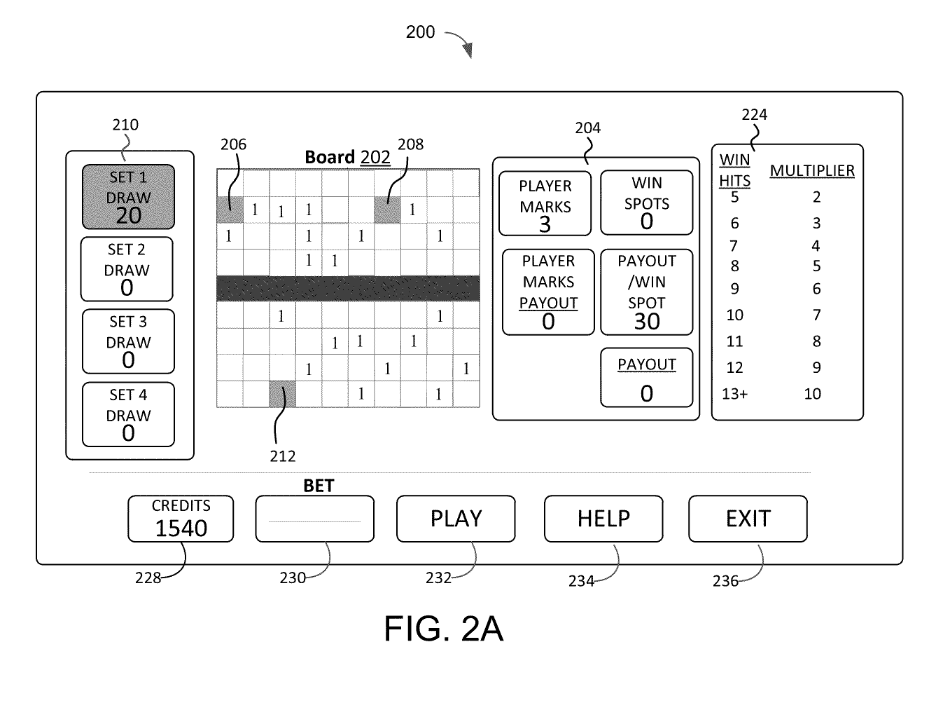

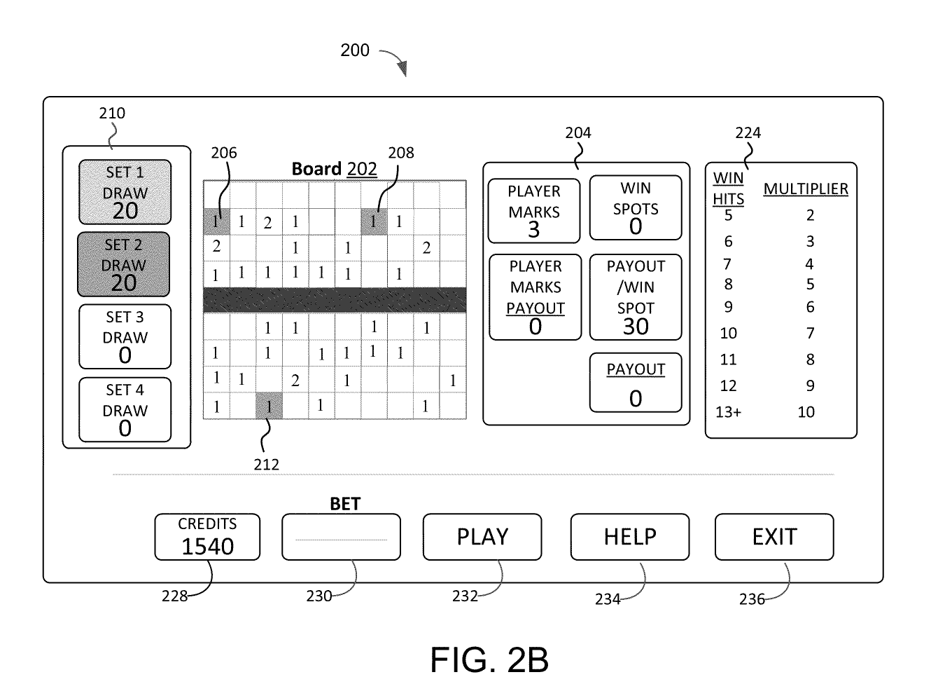

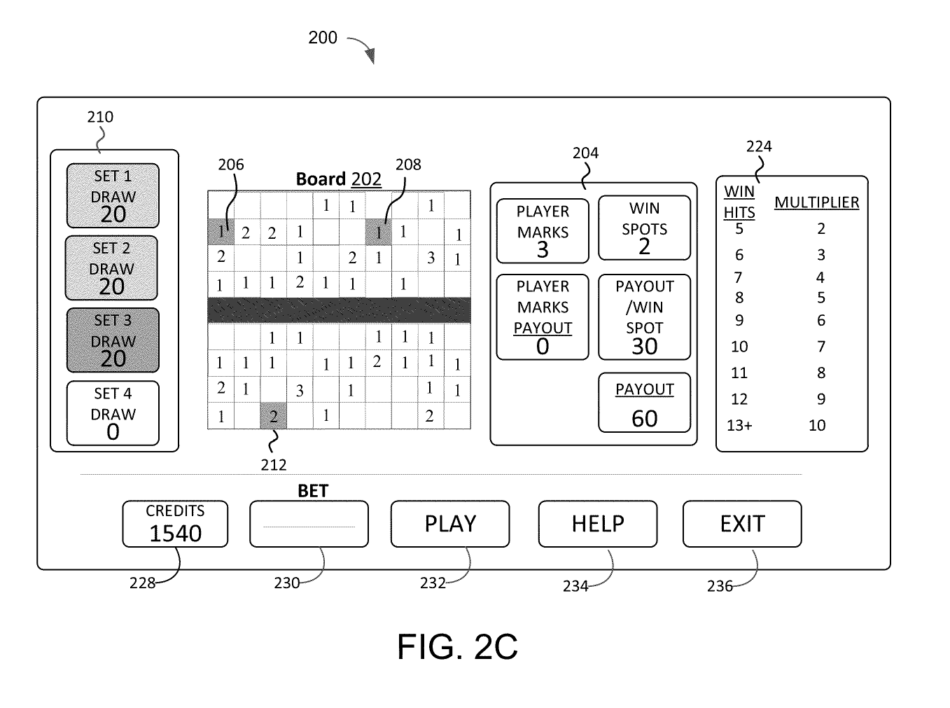

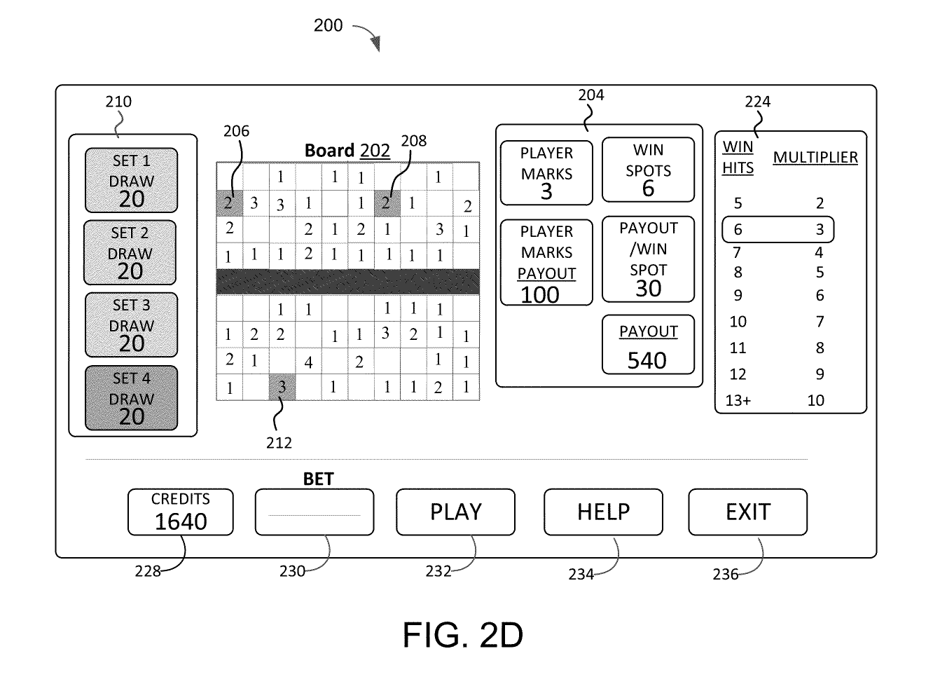

FIG. 2A illustrates a game 200, during which a player selects and marks spots on the board, which are used along with the multiple sets of draws to determine payout to the player. Similar to the board 102 in the game 100, a board 202 is displayed with eighty board spots. Although each spot on the board 202 is shown as a separate square, the board spots may be shown on the board 202 as numbered balls, numbered squares, or another visual representation.

As shown in a section 204, the player marked three spots on the board 202. In particular, the player selected spots 206, 208, and 212. Upon the player making these selections, the background color of these spots is updated to grey to emphasize the player's selections relative to the rest of the spots. In other implementations, the player selected spots may be updated in any other fashion to identify them to the player. For example, colors, animation, symbols, and other visual indicators may be used.

The spots may be selected for the player automatically. In particular, the player may request for these spots to be drawn by the game 200, three spots may be randomly or pseudo-randomly selected. Although FIG. 2A displays that three, player selected spots are selected, the player may be allowed to select any other number of spots. The number of spots that the player selects may be predetermined based on a variety of factors including any combination of, but not limited to, the total number of spots on the board, the number of drawn sets of spots and the number of spots in each drawn set, the bet amount, the player's play history, and others.

After the player selects the spots on the board 202 (or they are automatically selected for the player), a first set of spots is drawn. Section 210 of the user interface of the game 200 displays that the first set of twenty spots is drawn. These numbers may be randomly or pseudo-randomly drawn by the game from the eighty available numbers. The board is updated with the first set of drawn numbers by marking each corresponding board spot with “1” to indicate that those spots were hit once by draws. Although the board is updated with “1”s to displays the draws, any other visual indicators other than the “1”s may be used to signify the drawn spots. For example, the spots that correspond to the drawn numbers may be updated to the color red or any other color to signify that those spots were hit by draws once thus far.

Section 204 displays number of spots marked by the player, the total number of win spots, payout per win spots, and the total payout earned by the player during the game 200. Although the section 204 displays that the number of credits per winning spot is thirty, any number of credits or other types of award may be assigned for each winning spot. A paytable may be provided to calculate the payout for different numbers of winning spots (e.g., 100 credits for 4 winning spots, 300 credits for 5 winning spots, etc.).

A paytable (not shown) may be provided to specify awards for the draws hitting the player selected marks. In one implementation, the paytable may specify that when one of the player marks has been hit at least three times (or another predetermined number of times), a particular scatter award is won. For each number of player marks that have three or more hits by draws, an award may be awarded including any one of or combination of: additional credits, a multiplier, a predetermined number of free games, and a predetermined number of additional draws on the last set or for another game. In one implementation, for each number of player marks that have three or more hits, the same type of award may be provided. For example, fifty credits may be provided when one of the player marks have been hit at least three times, one hundred credits may be provided when two of the player marks have been hit at least three times, and three hundred credits may be provided when three of the player have been at least three times. The award can include any number of credits, or any other types of awards (e.g., free games, additional draws, multiplier, etc.)

In another example, the player may be awarded one hundred credits when one player mark is hit at least three times (i.e., when draws from at least three out of four sets match the player selected spot). In this example, if two of the player marks have been hit at least three times, a predetermined number of free games may be awarded. If all three player marks have been hit at least three times, a predetermined number of free games are awarded and play with ten extra draws on the last set. Alternatively, a multiplier can be applied.

In addition to awarding the player when the player selected marks are hit at least a predetermined number of times (e.g., three times), the player may be awarded for board spots being hit with draws three or more times (e.g., or any other number). Similar to the game 100, to qualify as a win spot during the game 200, a spot on the board 202 needs to be hit by three or more draws (or any other number). In other words, draws from three or more sets of drawn numbers need to hit the spot. As shown in FIG. 2A, because only one set of twenty numbers was drawn, there are no winning spots detected yet. As each set of drawn numbers is shown on the board in FIGS. 2B-D, the number of winning spots may increase.

When the number of winning spots is more than five, the player receives an award multiplied by a bet multiplier specified in a paytable 224, which illustrates multipliers associated with various total levels of winning spots. The paytable 224 is similar to the paytable shown for game 100. Controls for the game 200 includes buttons 232, 234, and 236 are provided to enable the player to play, get help, or exit the game 200 respectively. The total number of credits earned by the player is shown in a field 228. The player can also enter a bet into a field 230.

FIG. 2B illustrates results of a second set of spots being drawn during the game 200. As shown, the spots selected by the player are still displayed on the board 202. The section 210 indicates that a second set of twenty numbers was drawn. The twenty numbers are randomly (or pseudo-randomly) drawn from the available eighty numbers without consideration of the first set of drawn numbers that are shown on the board 202 in FIG. 2A.

As illustrated in FIG. 2B, the board 202 is updated with the second set of twenty drawn numbers. Four of the drawn numbers in the second set match the drawn numbers in the first set and are marked as “2”s on the board. The drawn numbers in the second set that do not match the numbers from the first set of drawn numbers are marked on the board as “1”s to indicate that the corresponding marked spots have only been hit once so far.

As shown, although four of the draws from the second set of drawn numbers matched the draws from the first set of numbers, none of the draws counted as winning spots. Thus, the payout to the player is still zero. In the implementation illustrated in FIG. 1A-D, spots that are hit three or more times are considered winning spots. In other embodiments, spots that are hit by draws from smaller number of sets of draws (e.g., two sets) may be considered as winning spots.

Now referring to FIG. 2C, results of a third set of spots being drawn during the game 200 are illustrated. As shown in the section 210, three out of the four sets were drawn. The third set of twenty numbers is randomly (or pseudo-randomly) drawn from the available eighty numbers without consideration of the first two sets of drawn numbers. Thus, the three sets of numbers, twenty numbers each, are drawn from the same set of eighty numbers.

The board 202 is updated to display the third set of twenty drawn numbers such that spots that are hit once are labeled as “1”, spots that are hit twice are labeled as “2”, and spots that are hit three times are labeled as “3”. In particular, two of the drawn numbers in the third set match the drawn numbers in the two drawn sets and are marked as “3”s on the board. Some of the drawn numbers in the third set match the numbers drawn in the first set of drawn numbers, while some drawn numbers in the third set match the numbers drawn in the second set of drawn numbers. Thus, some of the spots were updated to show “2” instead of “1”. As a result, a total of nine spots labeled as “2” are shown on the board. Spots that were not hit by draws in the first two sets of drawn numbers but which are hit by the spots in the third set of numbers are labeled as “1”. Some of the spots on the board 202 that were not hit by any drawn numbers remain blank.

The two spots on the board that were hit by the draws from all three sets (i.e., the spots that are labeled as “3”) are considered winning spots because they were hit three or more times (in this case three times). As shown in the section 204, two spots are winning spots, and the payout is 30 credits per wining spots. Thus, the payout amount is 60 credits (i.e., 30 credits multiplier by 2 for the 2 winning spots).

A multiplier in accordance with the paytable 224 is not awarded because none of the board spots were hit three or more times by draws. In particular, the spots 206 and 208 were hit once each, while the spot 212 was hit twice by draws.

Referring now to FIG. 2D, the results of the fourth and last set of spots being drawn during the game 200 is shown. For the fourth set, twenty numbers are randomly (or pseudo-randomly) drawn from the available eighty numbers without consideration of the first three sets of drawn numbers. Thus, as result of these numbers being drawn, some of the spots on the board may have no hits between the four sets of drawn numbers, while other spots on the board may each have one hit from one of the four sets of drawn numbers.

Other spots on the board may each have two hits from any of the four sets of drawn numbers. For example, one spot on the board may have a hit from the first set and a hit from the third set, while another spot on the board may have a hit from the second set and a hit from the fourth set. Other spots on the board may each have three hits from any of the three sets of drawn numbers (e.g., a hit from the first, second and fourth sets). Although not shown during the games 100 and 200, one or more spots on the board may have hits from each set of draws. For example, a spot may have a hit from each set of draws (i.e., from a first set of draws, a second set of draws, a third set of draws, and a fourth set of draws). When the total number of winning spots is five or more, a multiplier may be assigned in accordance with a paytable 224. The multiplier may be applied to the total number of credits earned by the player after the current set of draws was selected. In another implementation, the multiplier is applied to the cumulative payout earned by during all the draws of the current game.

A total of six spots are detected that have three or more hits. In particular one spot (labeled as “4”) on the board 202 had hits from all four drawn sets, while five spots (labeled as “3”) each have three hits. These spots qualify as winning spots, which is indicated in the section 104. Payout for six spots is one hundred eighty credits (i.e., 30 times 6). In addition, the player is awarded a multiplier in accordance with the paytable 224 because a total of six winning spots are detected. Thus, the total payout is one hundred eighty multiplied by the multiplier three, which is five hundred and forty credits.

The player selected spot 212 received three hits. A predetermined award may be provided to the player based on one of the player selected marks having three or more hits. As mentioned above, in one example, when one of the player marks has been hit at least three times, an additional scatter award is won. As shown, in the section 204, an award of 100 credits is won by the player for the player selected spot 212 being hit three times by draws. If one of the other two player selected spots would have received three or more hits, any of the following award or any combination thereof could be awarded by the player: additional credits, a predetermined number of free games, extra draws on the last set, a multiplier. The total credits field 228 is updated with the earned 640 credits for a total of 1,640 credits.

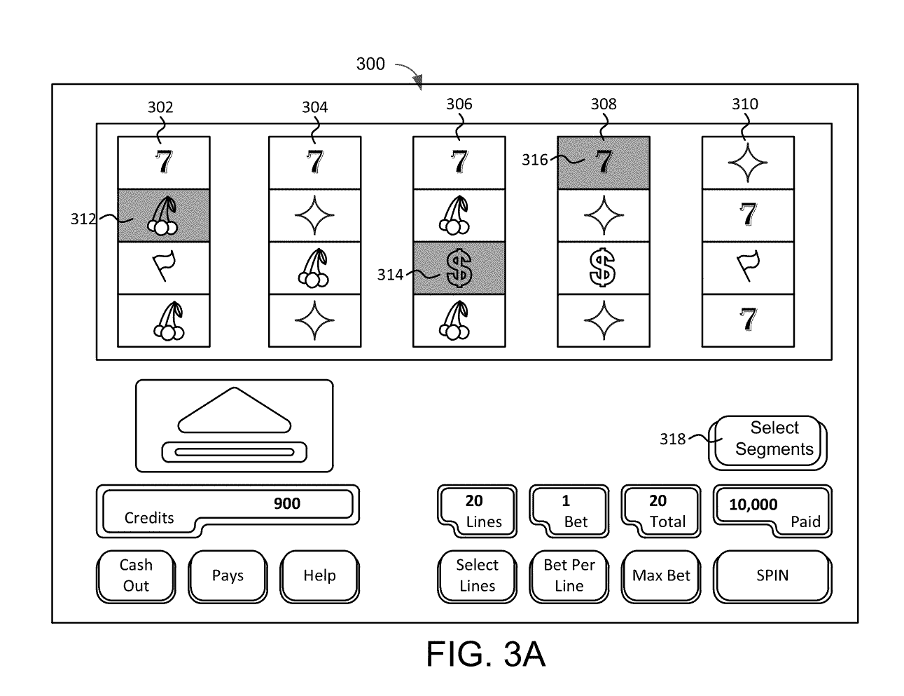

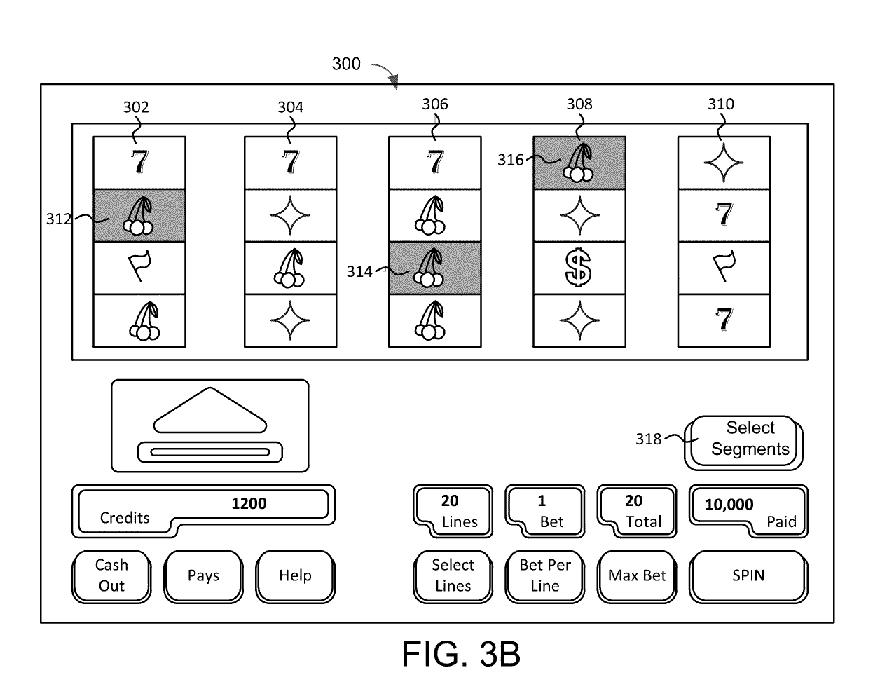

FIGS. 3A-B illustrate a slot game 300 during which the player can select a predetermined number of symbol locations, and win an award if the player selected locations display the same symbol. FIG. 3A illustrates the slot game 300 consisting of five reels 302, 304, 306, 308, and 310. Each reel consists of four segments. For example, the reel 302 includes four segments with the first segment showing number seven, the second segment showing cherries, the third segment showing a flag, and the fourth segment showing cherries. Segments in other reels 304, 306, 308, and 310 also show other symbols including diamonds and dollar signs. Although these listed symbols are shown in reels 302, 304, 306, 308, and 310, other symbols may be shown including, but limited to, spades, bells, hearts, horseshoes, various fruits such as grapes, watermelon, etc. Any other number of reels may be utilized (e.g., 3 reels) with any number of segments in each reel.

As shown in FIG. 3A, the player selected symbol locations for each reel. In particular, the player selected the second segment 312 in the reel 302, the third segment 314 in the reel 306, and the first segment 316 in the reel 308. Thus, the player selects specific symbol locations (as opposed to actual symbols) on three out of five reels. Although the player was only allowed to select three locations during the game 300, the player may be allowed to select another number of locations (e.g., 5 or 6 locations). In one implementation, the player may only select one segment in a reel. In another implementation, the player may select two or more segment in a reel.

In some embodiments, the player may select a button 318 to instruct the game 300 to randomly (or pseudo-randomly) select three segments in five reels. The player has the option of using the segment locations that the player selected in a previous slot game or erasing them choosing new ones. The slot game may provide various buttons for the player to control the slot game including, betting button, maximum bet button, help button, and others.

Once the player selects specific segment locations, the slot game spins the reels, and may award line wins. In addition to the line wins (or instead of), the game may award the player a scatter award if the player selected locations all display the same symbol. For example, if all the player selected locations show the same symbol, three hundred credits (or any other amount of credits) may be awarded to the player.

In one implementation, if at least a predetermined number of player selected segments show the same symbol, then an award is provided to the player. For example, if at least two of the three player selected segments show the same symbol or a particular symbol (e.g., cherries), then an award is provided. In this implementation, the more player selected segments match, the higher the award.

Now referring to FIG. 3B, different symbols are shown in the reels segments of the five reels after the slot game spins the reels (or simulates spinning of the reels). As shown, reel segments 312, 314, and 316 all show a cherries symbol. Accordingly, the player is entitled to an award of three hundred credits (or any other amount of credits). In another example, the player may be awarded a multiplier, additional credits, free plays, additional paylines, monetary award, or any combination thereof. When the symbols in all the player selected segments match, a bonus game may be triggered. The bonus game that is triggered includes: a slot game, a card game such as a video poker game, a keno game, a bingo game, a selection game, a skill-based or pseudo-skill based game.

Although not shown, multiple paylines may be drawn across the reels. When the paylines are generated and drawn, the player may receive additional credits or other types of awards for the paylines.

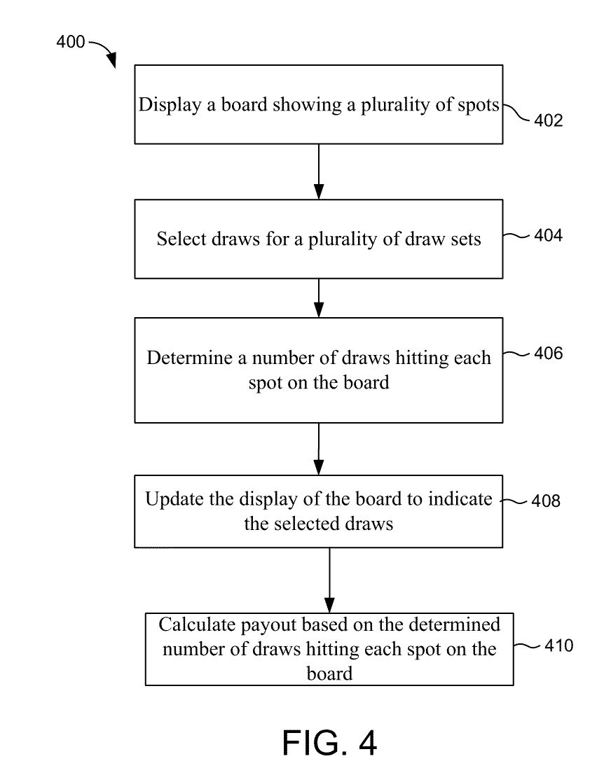

FIG. 4 is a flow diagram of a process 400 for providing a keno game during which multiple sets of draws are selected. The process 400 can be implemented on a computing device (e.g., a gaming machine, a user device, etc.). In one embodiment, the process 400 is encoded on a computer-readable medium that contains instructions that, when executed by the computing device, cause the computing device to perform operations of the process 400.

The process 400 includes displaying (402) a board showing a plurality of spots. The spots may be visually illustrated on the board as numbered balls, numbered squares, or any other numbered shapes or images, etc. For example, each board ball shown on the board may be labeled with a unique number between one and the number of available numbers (e.g., eighty). The set of available numbers may include eighty unique numbers or any other number of unique numbers (e.g., one hundred unique numbers from one to one hundred). As shown in FIGS. 1A-D, the board may display eighty white squares without showing any numbers.

At block 404, draws for a plurality of draw sets are selected. The number of draw sets may be any numbers (e.g., 4 sets, 5 sets, 10 sets, etc.). FIGS. 1A-D show four sets of draws selected and marked on the board. The number of spots in each set of draws may be the same. For example, each set may include twenty spots. The number of spots in each draw set may be predetermined in part based on the total number of spots on the board, the player bet, and other factors. Each set of the draws may be selected randomly or pseudo-randomly from the available spots (i.e., selected from available numbers), independently of the selection of the other sets.

At block 406, a number of draws hitting each spot on the board are determined. After all the sets of draws are selected, at least some of the spots may have been selected in two or more sets of draws. For example, a subset of the available spots were selected in two sets of draws, while another subset of spots was selected in three sets of draws, while another subset of numbers may have been selected in four sets of draws, etc. Some of the numbers from the set of available spots on the board were not selected in any of the sets of draws.

In one implementation, only the spots that have at least a predetermined number of hits by draws from the plurality of sets are counted in the determining step. For example, the predetermined number of hits may be three (as used in FIGS. 1A-D. In this example, the spots that have three or more hits by draws from the plurality of draw sets are considered winners and result in an award to the player. As shown, in FIG. 1D, five spots with three hits or more identified as well as one spot that was hit by draws from each set of draws. A total of five spots that have three or more hits is identified in FIG. 1D.

The display of the board is updated (block 408) to indicate (or mark) the selected draws. In some embodiments, the board may be updated after each set of draws is drawn as shown in FIGS. 1A-D. For example, after the first set of draws, the board spots corresponding to those draws may be update to reflect that those spots match one draw. As shown in FIG. 1A, those spots are updated to show “1”. However, any other visualizations may be used to indicate the selected draws on the board. For example, the color of all the spots on the board that match the draws in the first set may be updated to red. In this example, after the second set of draws is drawn, additional spots that had no hits from the first set of draws are updated with hits from the second set of draws (i.e., updated to color red), while the spots that are hits by draws from both the first and second set are updated to the yellow color. Triple hits may be shown with the green color, and quadruple hits may be shown with the gold color. Any other colors or visualizations may be utilized to indicate the draws from the multiple sets of draws on the board.

Payout is calculated (410) for the game based on the determined number of draws hitting each spot on the board. For example, as shown in FIG. 1D, a total number of spots that have three or more hits is 6. An award of credits may be provided for each spot that has a predetermined number of hits (e.g., three or more hits by draws from multiple sets of draws). The payout would be calculated by multiplying the total number of determined spots by a predetermined number of credits. Referring to FIG. 1D as an example, six spots multiplied by thirty credits results in one hundred eighty credits. When the total number of determined spots is over a threshold value, then a multiplier, additional credits, free plays, or any combination thereof may be awarded to the player.

In some embodiments, the player is allowed to mark spots on the board. The payout calculation would take into account how many of the player marks were hit at least a predetermined number of times (e.g., 3 times). FIG. 2D provides example of payout after four sets of draws are selected and the player selects three spots on the board.

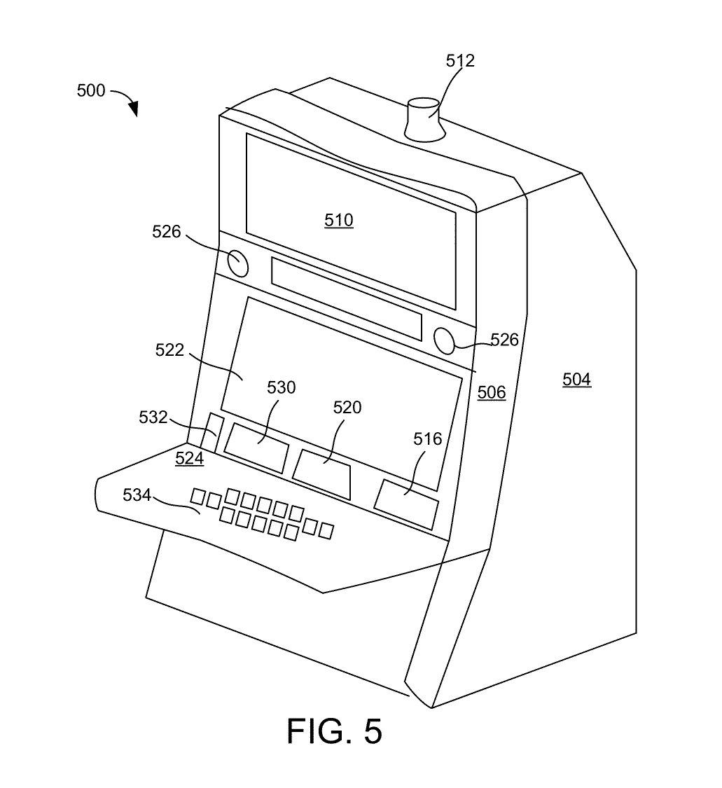

Referring to FIG. 5, a perspective drawing of an electronic gaming machine 500 is shown in accordance with described embodiments. The gaming machine 500 may include a main cabinet 504. The main cabinet 504 may provide a secure enclosure that prevents tampering with device components, such as a game controller (not shown) located within the interior of the main cabinet 504. The main cabinet 504 may include an access mechanism, such as a door 506, which allows the interior of the gaming machine 500 to be accessed. Actuation of the door 506 may be controlled by a locking mechanism. In some embodiments, the locking mechanism, the door 506, and the interior of main cabinet 504 may be monitored with security sensors of various types to detect whether the interior has been accessed. For instance, a light sensor may be provided within the main cabinet 504 to detect a change in light-levels when the door 506 is opened and/or an accelerometer may be attached to the door 506 to detect when the door 506 is opened.

The gaming machine 500 may include any number of user interface devices that convey sensory information to a user and/or receive input from the user. For example, the gaming machine 500 may include electronic displays 510 and/or 522, speakers 526, and/or a candle device 512 to convey information to the user of the gaming machine 500. The gaming machine 500 may also include a console 524 having one or more inputs (e.g., buttons, track pads, etc.) configured to receive input from a user. In one embodiment, the display 510 and/or the display 522 may be a touch screen display configured to receive input from a user. A controller (not shown) within the gaming machine 500 may run a game, such as a wager-based game (e.g., a keno game), in response to receiving input from a user via inputs located in the console 524, display 522, or display 510. For example, inputs located in the console 524 may be operated to place a wager in the game and to run the game. In response, the controller may cause the display 522 to show a wager-based game such as a keno game.

The gaming machine 500 may also include devices for conducting a wager-based game. For example, the gaming machine 500 may include a ticket acceptor 516 and a printer 520. In various embodiments, the gaming machine 500 may be configured to run on credits that may be redeemed for money and/or other forms of prizes. The ticket acceptor 516 may read an inserted ticket having one or more credits usable to play a game on the gaming machine 500. For example, a player of the gaming machine 500 may wager one or more credits within a video keno game. If the player loses, the wagered amount may be deducted from the player's remaining balance on the gaming machine 500. However, if the player wins and is awarded an award, the player's balance may be increased by the amount won and/or awarded. Any remaining credit balance on the gaming machine 500 may be converted into a ticket via the printer 520. For example, a player of the gaming machine 500 may cash out of the machine by selecting to print a ticket via the printer 520. The ticket may then be used to play other gaming machines or redeemed for cash and/or prizes. According to various embodiments, the gaming machine 500 may record data regarding its receipt and/or disbursement of credits.

In one embodiment, the gaming machine 500 may include a loyalty card acceptor 530. In general, a loyalty card may be tied to a user's loyalty account. A loyalty account may store various information about the user, such as the user's identity, the user's gaming preferences, the user's gaming habits (e.g., which games the user plays, how long the user plays, etc.), or similar information about the user. A loyalty account may also be used to reward a user for playing the gaming machine 500. For example, a user having a loyalty account may be given an award turn on the gaming machine 500 or credited loyalty points for playing the gaming machine 500. Such loyalty points may be exchanged for loyalty rewards (e.g., a free meal, a free hotel stay, free room upgrade, discounts, etc.).

Implementations of the subject matter and the operations described in this specification can be implemented in digital electronic circuitry, computer software, firmware or hardware, including the structures disclosed in this specification and their structural equivalents or in combinations of one or more of them. Implementations of the subject matter described in this specification can be implemented as one or more computer programs, i.e., one or more modules of computer program instructions, encoded on one or more computer storage medium for execution by, or to control the operation of data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

While any credit balances, any wagers, and any awards are displayed as amounts of monetary currency or credits in the embodiments described above, one or more of such credit balances, such wagers, and such awards may be for non-monetary credits or currency, promotional credits, and/or player tracking points or credits.

The operations described in this specification can be implemented as operations performed by a data processing apparatus on data stored on one or more computer-readable storage devices or received from other sources.

The term “client or “server” includes a variety of apparatuses, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, a code that creates an execution environment for the computer program in question, e.g., a code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interlinked by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, or a portable storage device (e.g., a universal serial bus (USB) flash drive). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well. For example, feedback provided to the user can be any form of sensory feedback, e.g., visual feedback, auditory feedback, or tactile feedback and input from the user can be received in any form, including acoustic, speech, or tactile input. In addition, a computer can interact with a user by sending documents to and receiving documents from a device that is used by the user. For example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interlinked by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown, in sequential order or that all illustrated operations be performed to achieve desirable results. In certain circumstances, multitasking and parallel processing may be advantageous. Moreover, the separation of various system components in the implementations described above should not be understood as requiring such separation in all implementations and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method comprising:
displaying a board showing a plurality of spots;
selecting, using one or more processors, draws for a plurality of draw sets;
determining, using the one or more processors, a number of draws hitting each spot on the board;
updating the display of the board to indicate the selected draws; and
calculating, using the one or more processors, payout based on the determined number of draws hitting each spot on the board.

2. The method of claim 1, further comprising receiving a player selected set of slots, wherein the player selected set of slots;

3. The method of claim 2, wherein calculating payout includes determining whether one or more of the player selected slots match any of the drawn slots in the plurality of draw sets.

4. The method of claim 1, wherein the spots in each set of draws is determined randomly from a set of available numbers.

5. The method of claim 1, wherein the display of the board is updated after each set of draws is selected.

6. The method of claim 5, wherein updating the display of the board includes updating visual characteristics of each spot corresponding to a draw in the last set of draws.

7. The method of claim 6, wherein the color of the spots is updated to indicate the total number of times that the spot has been hit by draws from the plurality of draw sets.

8. An electronic device for playing a keno game, comprising:
a display configured to display the keno game to a player having a keno board with a first predetermined number of keno board spots;
a user-input panel; and
a game controller having one or more data processors and one or more storage devices storing instructions that, when executed by the one or more data processors, cause the one or more data processors to perform operations comprising:
displaying a board showing a plurality of spots;
selecting draws for a plurality of draw sets;
determining a number of draws hitting each spot on the board;
updating the display of the board to indicate the selected draws; and
calculating payout based on the determined number of draws hitting each spot on the board.

9. The electronic device of claim 8, the operations further comprising receiving a player selected set of numbers, wherein the player selected set of numbers is a subset of available numbers;

10. The electronic device of claim 9, wherein calculating payout includes determining whether one or more of the player selected numbers match any of the drawn numbers in the predetermined number of drawn sets.

11. The electronic device of claim 8, wherein the numbers in each set of drawn numbers are determined randomly from the set of available numbers.

12. The electronic device of claim 8, wherein the display of the board is updated after each set of draws is selected.

13. The electronic device of claim 12, wherein updating the display of the board includes update visual characteristics of each spot corresponding to a draw in the last set of draws.

14. The electronic device of claim 13, wherein the color of the spots is updated to indicate the total number of times that the spot has been hit by draws from the sets of draws.

15. A method of providing game play of a wager-based game through a gaming machine having a controller, the method comprising:
displaying a grid comprising a plurality of grid spots;
receiving a player selection of a plurality of grid spots;
determining, by the controller, a symbol for each grid spot in the grid;
determining, by the controller, that symbols shown in each player selected spot match; and
calculating payout to the player based on the determined match.

16. The method of claim 15, further comprising updating display of the gaming machine including updating the grid with the determined symbol for each grid spot;

17. The method of claim 16, further comprising determining one or more payline, and updating the display of the grid with the determined paylines.

18. The method of claim 15, wherein the player selected grid spots are in different columns of the grid.

19. The method of claim 15, wherein the received player selection of grid spots is identical to the player selected spots from a previous game.

20. The method of claim 19, further comprising receiving a request from the player to automatically determine player selection spots, and determining the plurality of player selection grid spots from the plurality of grid spots.
